(19) United States
(12) Patent Application Publication
(10) Pub. No.: US 2026/0369036 A1
(43) Pub. Date: Nov. 19, 2026

(54) SYSTEM AND METHOD FOR CLASSIFYING AND ANNOTATING ENTITIES FROM IMAGES

(71) Applicant: Honeywell International Inc., Charlotte, NC (US)

(72) Inventors: Sethuraman Ramgopal, Bangalore (IN); Girish Kumrawat, Bangalore (IN); Murali D, Bangalore (IN)

(21) Appl. No.: 19/209,808

(22) Filed: May 16, 2025

(51) Int. Cl. G06V 10/764; G06T 5/70; G06T 7/00; G06T 9/00; G06T 17/00; G06V 10/32; G06V 20/70

(52) U.S. Cl. CPC G06V 10/764; G06T 5/70; G06T 7/0002; G06T 9/00; G06T 17/00; G06V 10/32; G06V 20/70; G06T 2207/20182

(57) ABSTRACT

The disclosure relates to a method and a system for classifying and annotating entities from images within an environment. The method includes acquiring image data representing entities using at least one imaging device, followed by determining spatial relationships between the entities. A simultaneous localization and mapping (SLAM) module processes the spatial relationships to generate a three-dimensional (3D) representation of the environment. Entity attributes are then extracted from the 3D representation using a trained model incorporating domain-specific templates. A retrieval-augmented generation (RAG) agentic system further analyzes the extracted attributes to identify the types and characteristics of the entities. Based on this identification, the entities are classified and annotated to enable structured representation and efficient organization. The method enhances entity recognition accuracy by integrating depth sensing, AI-driven classification, and contextual retrieval, making it applicable to various industries, including industrial automation, infrastructure monitoring, and digital asset management.

### TECHNICAL FIELD

The present disclosure relates to the field of computer vision and artificial intelligence (AI). More particularly, the present disclosure pertains to a system and method for ranking and tagging entities using image data captured from an industrial or operational environment through a combination of computer vision and generative AI models.

### BACKGROUND

Onboarding customers in asset-intensive industries, such as manufacturing plants, refineries, and hospitals, presents a significant challenge due to the extensive engineering efforts required to accurately identify, classify, and document a wide range of machinery, equipment, and other critical assets. Traditional methods for asset documentation primarily rely on manual data collection, where engineers or field operators physically inspect and record information about each piece of equipment. This process often involves taking photographs, making handwritten notes, and later transcribing the information into digital records. Such an approach is not only labor-intensive and time-consuming but also highly susceptible to human errors, inconsistencies, and data loss.

Furthermore, variations in lighting conditions, occlusions, and differences in equipment models further complicate the manual classification process, leading to inefficiencies and increased operational costs. As industries strive to enhance productivity and reduce downtime, there is a growing demand for automated solutions that streamline the onboarding process while ensuring accuracy and consistency in asset documentation.

The emergence of computer vision and AI-based classification techniques offers a promising avenue to automate the identification and annotation of assets in industrial environments. By using machine learning models trained on large datasets of industrial equipment images, AI-powered systems can detect, classify, and tag assets with high precision. However, existing AI-based solutions face several limitations. Many suffer from decreased accuracy in real-world scenarios where environmental noise, such as varying lighting conditions, reflections, and image distortions, can significantly impact recognition performance. Additionally, these solutions often struggle to correctly identify occluded or partially visible assets, leading to incomplete or erroneous classifications. Moreover, traditional AI models typically require substantial computational resources for both training and inference, making them impractical for deployment in resource-constrained environments such as remote manufacturing sites. Therefore, there is a need for an advanced system and method that not only enhances the accuracy of asset classification in complex environments but also optimizes computational efficiency, ensuring faster onboarding and improved asset management for industrial applications.

### SUMMARY

The present disclosure provides a system and method that uses computer vision and generative AI models, including diffusion models, to streamline the onboarding process for customers in asset-intensive industries. The disclosed system and method reduce onboarding cycle time while enhancing efficiency, optimizing resource utilization, and providing cost savings.

According to an aspect of the disclosure, a method for classifying and annotating entities from images within an environment is disclosed. The method comprises acquiring image data representing entities within the environment using at least one imaging device and determining spatial relationships between the entities. The method further comprises generating a three-dimensional (3D) representation of the environment using a simultaneous localization and mapping (SLAM) module based on the determined spatial relationships and extracting attributes of the entities from the generated 3D representation based on a trained model. Furthermore, the method comprises identifying types and characteristics of the entities using a retrieval-augmented generation (RAG) agentic system based on the extracted attributes, and classifying and annotating the entities based on the identified types and characteristics of the entities.

In some embodiments, the method further comprises processing the acquired image data for enhancing quality, extracting structural information, and facilitating the classification of the entities.

In some embodiments, processing the acquired image data comprises enhancing the quality of the acquired image data by reducing noise, normalizing variations, and improving visual clarity of the acquired image data, generating 3D and structural representations of the entities from the enhanced image data, and identifying and categorizing the entities based on generated 3D and structural representation.

In some embodiments, processing the acquired image data includes normalizing the image data captured under varying lighting conditions.

In some embodiments, the method further comprises decoding the acquired image data and processing the decoded image data through a diffusion model selector trained to denoise and reconstruct image features by applying a noise-based reverse learning process.

In some embodiments, the diffusion model selector reconstructs occluded or partially visible entities based on learned patterns from the trained model.

In some embodiments, the method further comprises performing post-processing and segment classification to refine the identified entities.

In some embodiments, the at least one imaging device comprises one or more cameras mounted on a user helmet.

In some embodiments, the SLAM module correlates distances between the entities within the environment to generate the 3D representation of the environment, measured by one or more depth-sensing devices.

In some embodiments, the trained model comprises domain-specific templates that include structured data models representing different operational environments to facilitate domain-specific entity classification.

In some embodiments, the one or more depth-sensing devices are Light Detection and Ranging (LIDAR) sensors.

In yet another embodiment, a system for classifying and annotating entities from images within an environment is disclosed. The system comprises at least one imaging device, one or more depth-sensing devices, a simultaneous localization and mapping (SLAM) module, an extraction module, an identification module, and a processing module.

The imaging device is configured to acquire image data representing entities within the environment. The depth-sensing devices are configured to determine spatial relationships between the entities. The SLAM module is configured to generate a three-dimensional (3D) representation of the environment based on the determined spatial relationships. The extraction module is configured to extract attributes of the entities from the generated 3D representation based on a trained model. The identification module is configured to identify types and characteristics of the entities using a retrieval-augmented generation (RAG) agentic system based on the extracted attributes. The processing module is configured to classify and annotate the entities based on the identified types and characteristics of the entities.

In some embodiments, the processing module is further configured to process the acquired image data for enhancing quality, extracting structural information, and facilitating classification of the entities.

In some embodiments, the processing module is further configured to enhance the quality of the acquired image data by reducing noise, normalizing variations, and improving visual clarity of the acquired image data, generate 3D and structural representations of the entities from the enhanced image data, and identify and categories the entities based on generated 3D and structural representation.

In some embodiments, processing the acquired image data includes normalizing the image data captured under varying lighting conditions.

In some embodiments, the system further comprises a decoding module configured to decode the acquired image data and process the decoded image data through a diffusion model selector trained to denoise and reconstruct image features by applying a noise-based reverse learning process.

In some embodiments, the diffusion model selector is configured to reconstruct occluded or partially visible entities based on learned patterns from the trained model.

In some embodiments, the processing module is further configured to perform post-processing and segment classification to refine the identified entities.

In some embodiments, the at least one imaging device comprises one or more cameras mounted on a user helmet.

In yet another embodiment, a non-transitory computer-readable medium is disclosed, having stored thereon computer-executable instructions that, when executed by a processor, cause the processor to execute a method for classifying and annotating entities from images within an environment. The method comprises acquiring image data representing entities within the environment using at least one imaging device and determining spatial relationships between the entities. The method further comprises generating a three-dimensional (3D) representation of the environment using a simultaneous localization and mapping (SLAM) module based on the determined spatial relationships and extracting attributes of the entities from the generated 3D representation based on a trained model. Furthermore, the method comprises identifying types and characteristics of the entities using a retrieval-augmented generation (RAG) agentic system based on the extracted attributes, and classifying and annotating the entities based on the identified types and characteristics of the entities.

The present disclosure provides an intelligent method and system for classifying and annotating entities from images within an environment. By using computer vision, depth sensing, SLAM, generative AI, and retrieval-augmented workflows, the disclosure ensures high-precision identification and categorization of assets across multiple domains. This approach enhances efficiency, accuracy, and automation in asset inventory management and environmental mapping.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1 illustrates a framework of the system and method to rank entities and tag them from images using computer vision according to an embodiment of this disclosure;

FIG. 2 illustrates the advanced AI-based framework for industrial asset identification, classification, and ranking according to an embodiment of this disclosure;

FIG. 3 illustrates a method for capturing, processing, and classifying entities within an environment using image data acquisition, spatial mapping, and AI-driven annotation techniques according to an embodiment of this disclosure;

FIG. 4 illustrates a system for generating operational insights from the emission efficiency of an asset according to an embodiment of this disclosure; and

FIG. 5 illustrates a schematic diagram of a communication apparatus according to an embodiment of this disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

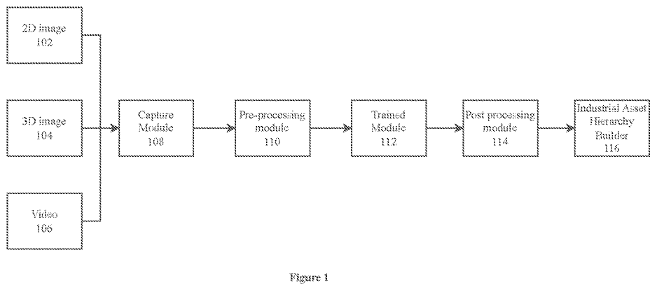

FIG. 1 illustrates a framework of the system and method to rank entities and tag them from images using computer vision, which processes visual data from industrial environments or other environments to generate a structured asset hierarchy according to an embodiment of this disclosure. The system is designed to automate the identification, classification, and ranking of industrial assets (interchangeably referred to as “entities”) using advanced computer vision and AI-driven methodologies. The framework begins with the acquisition of image and video data and progresses through multiple processing stages, ultimately producing a well-organized hierarchy of industrial assets.

At the initial stage, the system ingests various forms of visual data, including two-dimensional (2D) images 102 (interchangeably referred to as “image data”), three-dimensional (3D) images 104 (interchangeably referred to as “image data”), and video data 106, sourced from multiple acquisition devices (interchangeably referred to as “imaging device”). These sources may include fixed surveillance cameras, aerial drones, LiDAR-equipped devices, helmet-mounted vision systems, and mobile scanning units. The integration of these diverse data inputs enhances the system's ability to comprehensively analyze and interpret the industrial environment.

The 2D images 102 serve as foundational visual inputs, capturing surface-level details of entities within the environment. Meanwhile, the 3D images 104, generated using depth-sensing techniques such as stereo vision or LiDAR, provide critical spatial and volumetric data, enabling precise depth perception and geometric analysis. Additionally, video data 106 introduces temporal continuity, capturing dynamic movements and interactions within the environment. This continuous stream of information allows for real-time monitoring and tracking of objects, ensuring accurate detection even in changing conditions.

By incorporating multiple imaging modalities, the system achieves robustness in entity recognition and classification, adapting to various environmental challenges such as fluctuating lighting conditions, different camera angles, and partial occlusions of objects. The fusion of 2D, 3D, and video-based data enhances the completeness of the generated spatial representation, facilitating more accurate downstream processing, including object localization, annotation, and classification. This multi-modal approach ensures the system's reliability across diverse industrial applications, from infrastructure monitoring to automated inspection in complex operational settings.

Once the image and video data 102, 104, and 106 are collected, they are transmitted to the Capture module 108, which serves as the primary entry point for processing. This capture module 108 is responsible for ensuring the proper acquisition, formatting, and synchronization of the visual data, thereby maintaining the integrity and consistency of inputs across various imaging devices. The capture module 108 is designed to handle data from a wide range of sources, including static cameras, drone-based imaging systems, LiDAR-equipped devices, and wearable vision systems.

To enhance spatial awareness, the capture module 108 may integrate Simultaneous Localization and Mapping (SLAM) algorithms in conjunction with depth-sensing technologies. SLAM enables real-time mapping of the environment while concurrently tracking the position of the imaging device. This ensures that objects within the scene are accurately localized relative to one another, facilitating the generation of precise three-dimensional (3D) spatial representations. Depth-sensing technologies, such as LiDAR, structured light sensors, and stereo cameras, further augment this process by measuring the distance between entities and capturing fine-grained depth details.

The integration of these capabilities is particularly valuable in complex and dynamic environments such as manufacturing plants, hospitals, and industrial refineries. In such settings, assets are often densely arranged, requiring precise localization to differentiate between closely positioned objects. For instance, in a manufacturing facility, the ability to accurately map machinery, conveyor belts, and stored materials helps optimize operational efficiency and prevent misclassification. Similarly, in a hospital environment, precise localization ensures that medical equipment, patient monitoring devices, and essential supplies are correctly identified and tracked. In industrial refineries, where numerous pipelines, tanks, and control systems coexist in confined spaces, the capture module 108 maintains an accurate spatial inventory of assets.

By implementing SLAM and depth-sensing mechanisms within the capture module 108, the system ensures high-fidelity spatial mapping, robust object localization, and enhanced contextual understanding of the captured environment. These capabilities lay the foundation for subsequent processing stages, including attribute extraction, classification, and annotation of entities within the environment.

Once the data is captured, it is forwarded to the pre-processing module 110, where it undergoes multiple enhancement procedures to improve clarity, reduce noise, and standardize formats for seamless downstream processing. This module 110 refines raw data including raw image and video data, ensuring that the system operates with high-fidelity inputs, ultimately enhancing the accuracy of subsequent classification and annotation tasks.

To optimize image quality, the pre-processing module 110 applies various enhancement techniques. Specifically, contrast enhancement methods adjust brightness and color levels to improve visibility, particularly in low-light conditions or high-glare environments. Noise reduction algorithms remove grainy distortions and unwanted artifacts, ensuring that the images maintain sharpness and clarity. Edge detection techniques highlight object boundaries and structural contours, allowing for more precise segmentation of entities. Feature extraction processes analyze key visual patterns, identifying significant object characteristics that will be crucial for later classification.

For 3D images 104 and video streams/video data 106, the pre-processing module 110 takes additional steps to ensure spatial accuracy. In an embodiment, it may generate point cloud representations, which provide a structured visualization of objects in three-dimensional space. Point clouds consist of a dense set of data points mapped to the surfaces of detected entities, enabling the system to understand object geometry and spatial relationships in greater detail. This is particularly useful in industrial environments where depth perception is necessary for distinguishing between overlapping assets, identifying occluded objects, or reconstructing complex layouts.

Furthermore, the pre-processing module 110 performs format normalization, ensuring that images 104 and videos 106 from diverse sources-such as helmet-mounted cameras, LiDAR-equipped drones, and fixed surveillance systems are standardized into a unified structure compatible with the system's processing pipeline. By homogenizing data formats, the module 110 eliminates inconsistencies caused by variations in resolution, frame rates, and color depth, thereby preventing potential misinterpretations or classification errors.

Overall, the pre-processing module 110 ensures that only high-quality, structured, and optimized data is passed on for further analysis. By minimizing noise and enhancing critical visual details, this stage significantly improves the reliability of entity recognition, classification, and annotation in subsequent processing modules.

After pre-processing, the refined image data is forwarded to the trained module 112 (interchangeably referred to as “trained model”), which serves as the core component for entity classification and feature recognition. This module 112 applies advanced artificial intelligence (AI) techniques to analyze and categorize detected entities with high precision. By leveraging Generative AI models, including diffusion-based networks and retrieval-augmented generation (RAG) workflow (interchangeably referred to as “RAG agentic system”), the trainer module 112 enhances classification accuracy by learning from historical datasets, domain-specific taxonomies, and predefined classification criteria.

One of the key strengths of this module is its ability to utilize domain-specific classification templates tailored for different industries. These templates contain structured data models that define relevant asset categories, attributes, and hierarchical relationships specific to a given operational setting. For instance, in a hospital environment, the system can automatically differentiate between MRI machines, ventilators, and surgical instruments, ensuring that medical assets are correctly labeled and cataloged. Similarly, in a refinery, the trainer module 112 may classify industrial components such as valves, turbines, and storage tanks, based on their visual and functional characteristics.

The Generative AI models integrated into the trainer module 112 incorporate diffusion-based networks that progressively refine entity recognition by iteratively reducing noise and enhancing structural details. This is particularly useful in scenarios where images may be partially obstructed, captured in varying lighting conditions, or subject to distortions. The system reconstructs missing or unclear features, ensuring accurate classification even in suboptimal visual conditions.

Additionally, the retrieval-augmented generation (RAG) workflow improves entity classification. In an embodiment, the RAG retrieves relevant contextual information from pre-existing datasets, historical maintenance records, and industry-specific knowledge bases, enriching the classification process with valuable metadata. This contextual awareness ensures that asset labeling is not only based on visual attributes but also aligned with operational guidelines, usage patterns, and maintenance histories.

By automating the classification process, the trained module 112 significantly reduces the need for manual data entry and asset labeling. Traditionally, categorizing industrial assets required extensive human effort, often leading to inconsistencies and inefficiencies. However, with AI-driven training models, classification becomes faster, more accurate, and scalable across large datasets. This automation expedites asset tracking, enhances inventory management, and improves decision-making for industries that rely on accurate classification of complex equipment and infrastructure.

The trained module 112 ensures that entity classification is precise, context-aware, and adaptable to various industries. Through the integration of diffusion models, RAG workflow, and domain-specific classification templates, the system delivers a robust and scalable solution for asset recognition and annotation.

After the classification process is completed, the refined data is sent to the post-processing module 114, which ensures the accuracy, consistency, and contextual relevance of the classified entities. This module 114 performs multiple validation and enhancement functions, including verifying asset labels, filtering out misclassifications, and enriching metadata associated with each asset. These steps help eliminate errors that may arise during the classification process and ensure that the final dataset is structured and meaningful.

A key function of the post-processing module 114 is the hierarchical structuring of classified entities. Instead of treating each detected asset as an isolated entity, this module 114 organizes them into logical groupings based on their functional dependencies and spatial positioning. By doing so, the system can infer meaningful relationships between different assets within an environment. For example, in an industrial setting, the system can automatically associate a boiler with its corresponding heat exchangers, ensuring that related components are properly linked for operational tracking and maintenance. Similarly, in a healthcare environment, the system may recognize that a ventilator is functionally dependent on an associated oxygen supply unit and categorize them accordingly.

Beyond simple classification, the post-processing module 114 also enriches metadata. By integrating information from pre-existing databases, equipment manuals, maintenance logs, and industry-specific taxonomies, the system augments each classified entity with relevant operational details. This enrichment process ensures that the labeled assets are not only correctly identified but also carry additional contextual information, such as manufacturer specifications, maintenance schedules, operational guidelines, and compliance data.

Additionally, this module applies filtering mechanisms to remove redundant or incorrectly labeled entities, thereby improving the overall accuracy of the system. Misclassifications that may have occurred during the earlier classification stages are detected and corrected using validation rules, confidence thresholds, and cross-referencing with domain-specific knowledge bases. By refining the classification output, the Post-processing Module 114 ensures that only accurate and meaningful asset data is retained.

The final stage of the post-processing involves structuring the classified assets into a well-defined hierarchy, enabling more efficient organization, retrieval, and analysis. This hierarchical structuring ensures that entities are grouped in a way that reflects their real world relationships, making it easier for users to navigate asset inventories, conduct impact assessments, and optimize maintenance framework. For instance, in a power plant, different turbines, generators, and transformers can be systematically categorized based on their interdependencies, allowing for streamlined asset monitoring and predictive maintenance.

The post-processing module 114 serves as a critical refinement layer in the classification pipeline, ensuring consistency, accuracy, and completeness in asset labeling. By verifying labels, structuring relationships, enriching metadata, and filtering errors, this module enhances the usability and reliability of the classified dataset, making it a valuable asset for industries that rely on accurate and well-structured entity recognition.

The final stage of the framework is managed by the industrial asset hierarchy builder 116, which structures and organizes the classified assets into a well-defined hierarchical framework. This module 116 is designed to create a systematic representation of assets within a facility, ensuring that each entity is properly categorized and positioned within a logical structure. By doing so, the system enhances asset visibility, enables intelligent retrieval, and facilitates seamless integration with advanced digital tools such as digital twin systems, predictive maintenance platforms, and enterprise asset management (EAM) software.

One of the key functionalities of the industrial asset hierarchy builder 116 is its ability to automatically rank assets based on various operational parameters. These parameters may include an asset's operational importance, frequency of use, maintenance history, risk level, and interdependencies with other equipment. For instance, in a manufacturing plant, high-priority machinery such as conveyor systems and CNC machines may be ranked higher than auxiliary components like lighting systems or storage racks. Similarly, in a healthcare environment, critical assets such as ventilators and MRI machines may be prioritized over general hospital furniture. This ranking mechanism ensures that mission-critical assets receive the necessary attention in terms of maintenance, monitoring, and resource allocation.

Another essential aspect of this module 116 is its ability to streamline maintenance planning and asset lifecycle management. By structuring assets within a hierarchical framework, the system simplifies the identification of maintenance schedules, spare part requirements, and dependency chains. For example, if a particular industrial pump requires servicing, the system can automatically identify associated components, such as valves and pipelines, that may also require inspection. This structured approach minimizes downtime, enhances predictive maintenance strategies, and optimizes resource allocation across industrial operations.

The industrial asset hierarchy builder 116 also helps in digital twin integration. By maintaining a structured and continuously updated asset database, the system ensures that digital replicas of physical assets remain accurate and reflective of real-world conditions. This enables organizations to leverage digital twin technology for advanced simulations, operational forecasting, and real-time decision-making. For example, in an oil refinery, a digital twin model can use hierarchical asset data to simulate equipment performance under different operating conditions, allowing engineers to optimize efficiency and preempt potential failures.

A major advantage of this automated hierarchy-building process is the reduction in manual effort required for asset documentation and auditing. Traditionally, maintaining an up-to-date asset inventory required extensive manual input, which was prone to human error and inconsistencies. By leveraging AI-driven classification and ranking techniques, the system ensures that asset documentation is continuously updated in real time, reflecting changes such as equipment additions, removals, or maintenance actions. This significantly reduces the need for time-consuming manual audits and ensures that asset records remain accurate and reliable.

Further, the automated tagging and ranking system enhances operational efficiency by enabling faster onboarding of new engineers, technicians, and facility managers. Since assets are systematically categorized and ranked, new personnel can quickly familiarize themselves with the asset landscape, access relevant documentation, and understand equipment dependencies without the need for extensive manual training. This is particularly beneficial in industries with high workforce turnover or complex asset environments, such as power plants, data centers, and aerospace facilities.

The industrial asset hierarchy builder 116 ensures that assets are systematically structured, ranked, and continuously updated. By enhancing asset retrieval, maintenance planning, and digital twin integration, this module significantly improves operational efficiency, reduces downtime, and minimizes the reliance on manual documentation processes. The ability to dynamically adapt to changes in asset configurations ensures that organizations maintain an accurate, real-time representation of their infrastructure, enabling data-driven decision-making and optimized resource management.

The discussed approach presents a streamlined framework that automates the identification, classification, and hierarchical structuring of industrial assets using an AI-driven approach. The system optimizes asset inventory processes by leveraging multi-modal data inputs, robust AI classification, and structured post-processing, ultimately reducing manual effort and improving asset visibility across various industries.

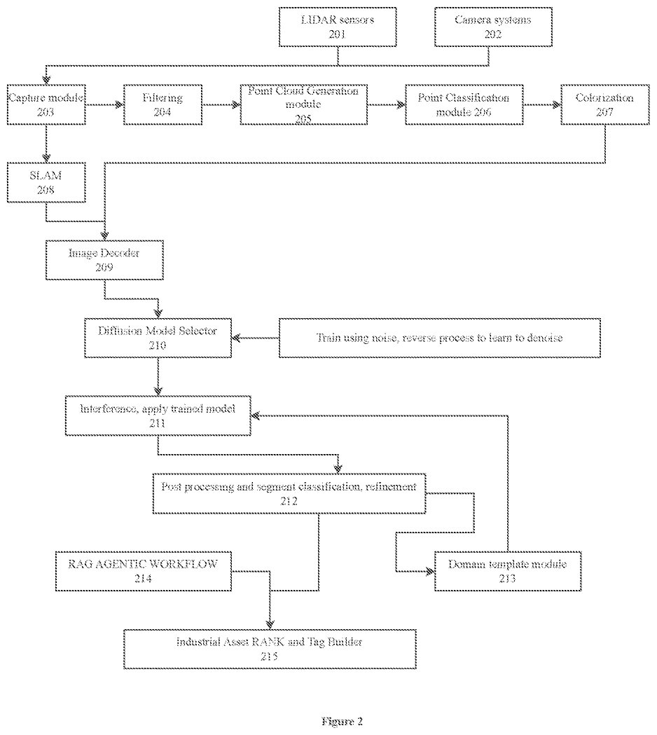

FIG. 2 illustrates the advanced AI-based framework for industrial asset identification, classification, and ranking, using LiDAR and camera-based vision processing to enhance asset recognition according to an embodiment of this disclosure. The system integrates Simultaneous Localization and Mapping (SLAM), diffusion-based AI models, and retrieval-augmented generation (RAG) workflows to systematically capture, process, and classify industrial assets, ultimately building a ranked and tagged asset hierarchy. This framework ensures high precision in asset detection, classification, and contextual ranking for use in industries such as manufacturing, healthcare, and large-scale infrastructure management.

The framework begins with the acquisition of environmental data from two primary sources: LiDAR sensors 201 and camera systems 202. In an embodiment, each of these data sources contributes distinct yet complementary information, allowing for a comprehensive representation of the industrial setting. The LiDAR 201 is responsible for capturing depth information by generating dense point cloud data, which provides a three-dimensional (3D) spatial map of the environment. Further, the LiDAR 201 allows for precise measurement of distances, object contours, and spatial relationships between assets. On the other hand, the cameras 202 capture high-resolution visual data, including color, texture, and surface details, which are essential for accurate object recognition and classification.

By combining these two sources 201, 202, the system creates a multi-modal dataset that enhances the accuracy of object detection and scene understanding. For example, while a LiDAR sensor can identify the presence of a machine by mapping its geometric structure, a camera can determine its color, surface texture, and possible wear or damage. This fusion of spatial and visual data is particularly useful in industrial settings where environmental conditions, such as lighting variations or partial obstructions, may affect data reliability if only a single modality is used.

To ensure seamless integration of the LiDAR 201 and the camera 202 data, the capture module 203 serves as the initial processing stage, where raw sensor inputs are ingested and synchronized. This module aligns LiDAR point clouds with corresponding camera images, ensuring that depth information is accurately mapped to visual attributes. Proper synchronization is crucial, as even minor misalignments between 2D and 3D data can lead to inaccuracies in entity classification and spatial positioning.

The capture module 203 also standardizes data formats and ensures that information is collected at consistent time intervals, preventing discrepancies caused by sensor latency or misalignment. In an embodiment, the capture module 203 is the same as the capture module 108 disclosed in FIG. 1. In dynamic environments, such as construction sites, hospitals, or manufacturing plants, where assets and personnel are constantly in motion, the capture module 203 ensures that data acquisition occurs in real-time or near-real-time. This allows the system to maintain an up-to-date representation of the environment, supporting applications such as automated inventory tracking, real-time hazard detection, and predictive maintenance.

Further, this initial data acquisition stage lays the foundation for accurate Simultaneous Localization and Mapping (SLAM), which is critical for generating a coherent 3D representation of the environment. By ensuring precise spatial mapping, the capture module 203 enables downstream modules to perform tasks such as object recognition, asset classification, and spatial analysis with higher accuracy and reliability.

After the data is captured from the LiDAR sensors 201 and cameras 202, it undergoes a refinement process to improve accuracy and usability. The first step in this process is filtering 204, where unwanted noise, redundant data points, and irrelevant background elements are systematically removed. The raw LiDAR data often contains artifacts caused by sensor limitations, environmental factors such as dust or fog, or interference from reflective surfaces. By eliminating these inconsistencies, the filtering 204 ensures that only meaningful data is retained for further processing. This step prevents errors during subsequent analysis and improves the reliability of object classification and spatial mapping.

Once the filtered LiDAR data is prepared, it is processed by the point cloud generation module 205, which organizes the remaining data points into a structured three-dimensional (3D) representation of the scanned environment. This 3D point cloud serves as the foundational layer for spatial analysis, allowing the system to accurately capture object dimensions, contours, and relative positioning. The structured nature of the point cloud makes it possible to model complex industrial environments with precision, supporting applications such as infrastructure assessment, automated navigation, and digital twin integration.

Simultaneously, the point classification module 206 assigns semantic labels to different elements within the 3D scene. Using predefined classification criteria, this module 206 differentiates between key categories such as equipment, infrastructure components, and background elements. For instance, in an industrial facility, the module 206 may identify and label machinery, structural elements such as beams and walls, and environmental factors such as floors and ceilings. The classification process ensures that downstream analysis modules can distinguish between actionable assets and non-critical background data, thereby improving efficiency in tasks such as asset tracking, maintenance scheduling, and operational monitoring.

To further enhance the usability and interpretability of the point cloud data, the colorization module 207 integrates color and texture information obtained from camera feeds. Since LiDAR data alone lacks inherent color details, the addition of camera-based texture mapping provides a richer, more informative representation of the environment. This step enables both human operators and AI models to distinguish between objects based on their visual properties, improving recognition accuracy. For example, in a warehouse setting, colorization can help differentiate between various types of inventories, identify labels on machinery, or distinguish warning signs from regular infrastructure.

By combining these processing steps-filtering, point cloud generation, point classification, and colorization-the system creates a highly structured, semantically rich, and visually enhanced 3D representation of the environment. This refined dataset forms the foundation for subsequent stages such as object recognition, spatial mapping, and AI-driven decision-making, ultimately improving the efficiency and reliability of industrial asset management and environmental monitoring applications.

The system utilizes Simultaneous Localization and Mapping (SLAM) 208 to achieve high-precision spatial mapping and positioning of detected assets within an environment. The SLAM 208 is a computational approach that enables the system to construct a real-time, continuously updated map of the surroundings while simultaneously determining the exact location of assets relative to one another. This capability is especially valuable in environments where traditional GPS-based positioning is unreliable or infeasible, such as indoor industrial facilities, underground tunnels, dense manufacturing plants, and complex construction sites.

By leveraging depth-sensing technologies, including LiDAR, stereo cameras, and inertial measurement units (IMUs), the SLAM module 208 continuously tracks objects within the environment, even in the presence of movement or structural changes. As assets are detected, the SLAM 208 correlates their spatial relationships, ensuring that their positions are accurately mapped. This process maintains an updated and structured representation of industrial spaces, where machines, equipment, and personnel frequently move.

One of the key advantages of using the SLAM 208 is its ability to handle dynamic environments, where assets or objects are constantly shifting. Unlike static mapping techniques, which may become outdated quickly, the SLAM 208 updates in real-time, ensuring that moving assets such as forklifts, automated guided vehicles (AGVs), or robotic arms are continuously positioned within the system's 3D representation. Additionally, the SLAM 208 enables the system to navigate and track objects in GPS-denied areas, such as underground mines, shipyards, or densely built urban environments.

Beyond spatial positioning, the SLAM 208 enhances asset classification and contextual awareness by aligning detected entities with existing facility blueprints or digital twin models. This ensures that assets are not just positioned correctly but also associated with their respective functions and dependencies. For example, in an oil refinery, the SLAM 208 can link a specific pipeline section to corresponding valves and monitoring systems, allowing for more effective maintenance planning and operational oversight.

After SLAM 208 establishes precise spatial relationships and asset positioning, the system proceeds with image reconstruction and AI-driven classification through the image decoder 209 and diffusion model selector 210. These modules work in tandem to refine and enhance visual data before performing advanced recognition and segmentation tasks.

The image decoder 209 is responsible for reconstructing structured image data from the raw visual inputs acquired earlier. This step ensures that degraded, distorted, or incomplete images-resulting from factors such as poor lighting conditions, motion blur, occlusions, or sensor limitations are corrected and optimized for subsequent AI processing. The decoder enhances the quality of image features, aligning them with spatial data obtained from the SLAM 208 to preserve geometric consistency and improve object differentiation.

Once the images have been structured and refined, the diffusion model selector 210 determines the most suitable AI model for asset recognition and segmentation. The diffusion-based learning approach used in this module is particularly effective for reconstructing missing or occluded details within images. The training methodology involves introducing noise into image data and then learning to reverse the noise, allowing the system to progressively refine and restore high-detail features from low-quality or ambiguous image inputs.

This noise-based reverse learning process provides significant advantages in industrial environments where visual obstructions, variable lighting conditions, and partial occlusions are common challenges. For example, in a warehouse or factory setting, assets/entities may be partially hidden behind other objects or obscured due to dust, reflections, or shadows. The diffusion model 210 enhances recognition accuracy by intelligently reconstructing the obscured portions of these assets, allowing the system to identify and classify them with greater confidence.

Furthermore, the diffusion model selector 210 dynamically chooses the best AI model based on the specific characteristics of the input data. It can switch between models optimized for different types of environments, such as high-density equipment zones, outdoor industrial sites, or controlled laboratory settings. This adaptability ensures that each asset is analyzed using the most effective AI framework, leading to precise segmentation, accurate categorization, and improved feature extraction.

Once the AI model is fully trained, it transitions to the inference phase 211, where the trained model is deployed to classify industrial assets in real-time operational environments. At this stage, the model applies its learned patterns and features to new, incoming data streams, identifying and categorizing assets with high efficiency and accuracy. The real-time classification enables automated asset recognition, reducing reliance on manual labeling and improving operational framework across industrial domains.

Following the initial classification, the post-processing and segment classification module 212 refines and validates the results to ensure structured, coherent, and accurate asset identification. In an embodiment, the post-processing module 114 disclosed in FIG. 1 can be used to refine and validate the results. The module 212 filters out false positives by cross-verifying classifications against reference datasets, minimizing errors and retaining only valid assets. Additionally, it merges similar asset categories by consolidating overlapping classifications, ensuring clarity and relevance in asset grouping. For instance, if a storage tank is classified under both “Reservoir” and “Chemical Container,” the system intelligently selects the most relevant classification based on contextual understanding. The module 212 also organizes detected assets into meaningful groups based on functional relationships and hierarchical dependencies, which is particularly useful in complex environments such as factories, refineries, and hospitals. For example, in a power plant, the module may automatically group turbines, transformers, and control panels under a power generation system, facilitating better asset tracking and management.

To further enhance classification accuracy and domain relevance, the domain template module 213 incorporates industry-specific knowledge into the classification framework. By leveraging predefined taxonomies, operational guidelines, and best practices, it ensures that the classification aligns with established industrial standards and regulatory requirements. For instance, in a healthcare setting, the module distinguishes between diagnostic tools such as MRI machines and X-ray systems and therapeutic equipment like ventilators and infusion pumps. Similarly, in manufacturing, it aligns asset classifications with production line components such as conveyor systems, robotic arms, and material feeders, while in oil refineries, it categorizes assets based on process stages, such as cracking units, distillation columns, and heat exchangers.

By integrating industry-specific templates, the domain template module 213 standardizes asset classifications, ensuring consistency across facilities and compliance with industry regulations. This functionality enhances the system's usability in real-world applications, enabling seamless asset tracking, maintenance planning, and integration with digital twin platforms.

The RAG (Retrieval-Augmented Generation) Agentic Workflow 214 enhances asset ranking by integrating AI-driven knowledge retrieval with real-time classification. This workflow ensures that asset information remains accurate, contextually relevant, and continuously updated by cross-referencing classified assets with external databases, historical maintenance logs, and industry-specific knowledge repositories. Unlike traditional classification systems that rely solely on predefined taxonomies, the RAG workflow dynamically retrieves and synthesizes information from multiple sources, allowing it to provide richer asset metadata and more informed decision-making.

To achieve precise ranking, the system evaluates various parameters associated with each asset. One of the key factors considered is usage frequency, where assets that are frequently utilized, such as conveyor belts in a production facility or MRI machines in a hospital are assigned higher priority rankings. Maintenance history is another critical determinant; assets that have undergone frequent repairs or have a history of recurring issues are flagged for closer monitoring. Additionally, the system considers an asset's operational importance, ensuring that mission-critical components, such as turbines in a power plant or ventilators in an intensive care unit, are given higher rankings due to their role in overall system functionality.

The RAG workflow also incorporates failure risk analysis by assessing patterns in historical failures, predictive maintenance reports, and sensor data. By identifying assets prone to breakdowns based on degradation trends or environmental stress factors, the system proactively prioritizes assets requiring urgent inspection or preventive maintenance. Further, the AI-driven retrieval mechanism continuously updates asset rankings as new information becomes available, adapting to evolving operational conditions.

The final output is processed by the industrial asset rank and tag builder 215, which organizes assets into a structured hierarchy, assigning appropriate labels and priority scores. This ranked asset hierarchy supports predictive maintenance, automated inventory management, and digital twin applications, significantly reducing manual effort and improving operational efficiency.

The disclosed method presents a highly automated, AI-driven pipeline for industrial asset recognition, classification, and ranking. By integrating multi-modal data sources, advanced AI models, and contextual retrieval mechanisms, the system achieves unparalleled accuracy in asset identification and ranking, optimizing industrial asset management at scale.

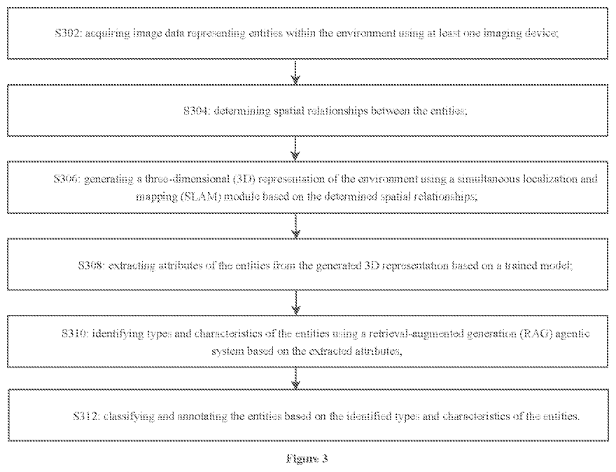

FIG. 3 illustrates a method for capturing, processing, and classifying entities within an environment using image data acquisition, spatial mapping, and AI-driven annotation techniques according to an embodiment of this disclosure. The method integrates depth sensing, 3D reconstruction, retrieval-augmented generation (RAG), and diffusion-based denoising models to ensure entity identification and classification across diverse operational environments.

At step S302, the method commences with the acquisition of image data representing entities present within an environment. This step serves as the foundation for subsequent classification, mapping, and annotation processes. The image data is captured using at least one imaging device, which in some implementations comprises one or more cameras mounted on a user helmet. This wearable, head-mounted configuration is strategically designed to provide a dynamic and real-time perspective of the user's surroundings, ensuring that the imaging device captures entities from the user's viewpoint as they move through the environment.

By integrating head-mounted cameras, the system benefits from continuous and unrestricted field-of-view adjustments, mimicking the natural observational behavior of human operators. This approach contrasts with traditional fixed-position cameras, which may have static coverage zones and require multiple installations to achieve comprehensive coverage. The wearable configuration is particularly advantageous in high-mobility environments where users frequently navigate through complex, dynamic, or large-scale spaces, such as industrial facilities, warehouses, construction sites, and field-based asset management zones.

Further, this real-time, first-person imaging approach ensures that entities of interest are captured from optimal angles and distances, as the imaging device moves in conjunction with the user's head movements. This enhanced flexibility facilitates comprehensive scene understanding, improving the accuracy of object recognition, depth perception, and spatial mapping.

The imaging system may also incorporate additional sensors, such as depth cameras, infrared sensors, or LiDAR modules, to enhance scene perception under diverse environmental conditions. For instance, in low-light or obscured environments, infrared-assisted imaging can help identify entities that might not be fully visible in standard optical images. Similarly, LiDAR-enhanced depth sensing can improve spatial accuracy by providing precise distance measurements between detected objects.

The use of helmet-mounted cameras provides a first-person perspective, ensuring comprehensive and context-aware data acquisition that aligns with the real-world movement and operational needs of users in industrial and field-based environments.

At step S304, the method involves establishing spatial relationships between the detected entities using depth-sensing devices, which may include Light Detection and Ranging (LiDAR) sensors, stereo cameras, or other depth-mapping technologies. These sensors determine relative distances, orientations, and positional interdependencies between the various entities within the environment.

The LiDAR sensors operate by emitting laser pulses that bounce off surfaces and return to the sensor, allowing for precise distance measurements based on time-of-flight calculations. This enables the system to construct a highly detailed and accurate depth map of the surrounding environment. In addition to LiDAR, stereo cameras can be used to estimate depth by analyzing the disparity between two slightly offset images, mimicking human binocular vision. Other depth-sensing techniques, such as structured light sensors or time-of-flight (ToF) cameras, may also be employed depending on the application requirements and environmental conditions.

Once the depth-sensing devices establish these spatial relationships, the Simultaneous Localization and Mapping (SLAM) module processes the depth data to generate a three-dimensional (3D) representation of the environment at step S306. The SLAM algorithm is responsible for mapping the environment while simultaneously tracking the position of the imaging device (or user) in real-time. It does so by integrating sensor data to correlate distances, detect object boundaries, and refine positional accuracy, effectively constructing a structured and navigable 3D spatial map of the surroundings.

The SLAM-generated 3D representation provides a structured framework for further data processing, including object localization, scene understanding, and navigation assistance. The object localization ensures that each detected entity is accurately positioned within the mapped space, enabling precise tracking. The scene understanding helps distinguish between different objects, surfaces, and environmental structures, aiding in classification. The navigation assistance in mobile applications, such as autonomous robots or augmented reality (AR) systems, SLAM aids in path planning and obstacle avoidance.

The generated 3D spatial representation serves as a foundation for additional data extraction and analysis in subsequent steps. By using high-resolution depth data and SLAM-based localization, the system can accurately model complex environments, supporting applications such as industrial automation, infrastructure inspection, and autonomous navigation.

At step S310, the method involves an extraction module that retrieves entity attributes from the three-dimensional (3D) representation of the environment. This extraction is performed using a trained artificial intelligence (AI) model, which has been optimized for identifying and classifying entities based on their characteristics, spatial relationships, and contextual relevance within the operational setting.

The trained AI model utilizes domain-specific templates, which serve as structured data models tailored for different operational environments. These templates encapsulate predefined classification rules, object attributes, and contextual information relevant to specific industries, ensuring that entity identification and categorization remain accurate, efficient, and contextually appropriate. By leveraging these structured data models, the system standardizes object classification and improves recognition accuracy across various applications.

The domain-specific templates enhance classification precision by incorporating industry-specific taxonomies, allowing the system to map detected entities to relevant categories, attributes, and hierarchical structures. For example, in a construction environment, entities may be classified into distinct categories such as heavy machinery (e.g., excavators, bulldozers, cranes), infrastructure components (e.g., steel beams, concrete structures, scaffolding), and personnel (e.g., construction workers, site supervisors, safety inspectors). Similarly, in a healthcare setting, the classification scheme may include medical devices (e.g., infusion pumps, ventilators, imaging systems), patient monitoring systems (e.g., ECG machines, pulse oximeters), and hospital assets (e.g., hospital beds, diagnostic tools, sanitation equipment).

To achieve high classification accuracy, the AI model employs feature extraction techniques that analyze various entity attributes. Geometric and spatial analysis examines the size, shape, and orientation of detected entities to understand their structure and positioning within the environment. Texture and material recognition identifies surface properties to differentiate between objects, such as distinguishing metal from plastic or glass. Additionally, functional inference determines an entity's role and purpose based on its context and usage patterns, ensuring accurate classification and contextual understanding. By leveraging these advanced feature extraction techniques, the system improves entity identification and classification across diverse operational environments.

Further, the trained AI model continuously improves over time by incorporating new data from different operational settings, thereby refining its ability to recognize novel entities, adapt to environmental variations, and enhance classification robustness. The extraction module integrates insights from multiple sensor sources, such as LiDAR, RGB cameras, infrared sensors, and depth sensors, to ensure a comprehensive and multi-modal understanding of the detected entities.

At step S312, an identification module determines the types and characteristics of the detected entities using a Retrieval-Augmented Generation (RAG) agentic system. The RAG system enhances classification by integrating real-time entity detection with retrieval-based knowledge augmentation, ensuring that entity annotations are not only precise but also contextually enriched with historical data, operational guidelines, and domain-specific insights. By referencing a vast repository of pre-existing datasets, the RAG system can retrieve contextually relevant metadata, such as previous classifications, functional descriptions, and compliance requirements, thereby improving the accuracy and relevance of annotations.

Once the RAG-based retrieval process is complete, a processing module performs final classification and annotation. This step ensures that each detected entity is accurately labeled according to its identified attributes, functionality, and operational significance. The classification framework follows a hierarchical approach, aligning entities with predefined taxonomies within their respective industries. For instance, in an industrial setting, a detected entity such as a robotic arm may be classified under automation equipment, while in a medical facility, an infusion pump may be categorized under patient care devices. Additionally, the system may apply semantic tagging to facilitate efficient searchability and integration into digital asset management platforms.

Beyond simple labeling, the annotation process may include structured metadata tagging, which embeds operational parameters, maintenance schedules, or safety compliance details into the entity profile. This structured approach not only enhances classification accuracy but also supports automated decision-making processes, predictive analytics, and intelligent workflow automation. By leveraging retrieval-augmented classification and advanced processing techniques, the system ensures a robust, scalable, and industry-specific entity identification framework, ultimately optimizing operational efficiency and knowledge management across various domains.

The method further comprises pre-processing steps designed to enhance image data quality, improve structural information extraction, and ensure image normalization across diverse environmental conditions. These pre-processing techniques refines raw image inputs, allowing the system to maintain high detection accuracy despite challenges such as low-light settings, occlusions, shadows, glare, or dynamic lighting variations.

One critical aspect of pre-processing is image enhancement, which includes techniques such as contrast adjustment, noise reduction, and sharpening filters to improve clarity and detail within the captured image. For instance, in low-light environments, adaptive histogram equalization techniques may be applied to brighten dark areas without overexposing highlights. Similarly, in environments with excessive glare or reflections, polarization-based filtering can be used to minimize unwanted distortions and improve the visibility of objects.

Another essential component of pre-processing is structural information extraction, which involves the identification of key geometric features within an image. Advanced edge-detection algorithms, contour mapping, and depth estimation techniques are utilized to accurately distinguish object boundaries, enabling better segmentation and classification of detected entities. In cases where partial occlusions occur, such as an entity being obstructed by another object predictive reconstruction models may infer missing details based on previously learned patterns.

Further, image normalization is applied to ensure consistency across datasets captured under varying environmental conditions. This process includes color correction, white balance adjustment, and shadow compensation, allowing the system to generate standardized image outputs regardless of lighting disparities. For example, images captured in an outdoor industrial setting under bright sunlight may undergo dynamic range adjustment to prevent overexposure, while those taken in indoor or nighttime environments may be enhanced using low-light amplification techniques.

By incorporating these robust pre-processing mechanisms, the method ensures that feature extraction remains consistent, reliable, and optimized for downstream processing steps. This significantly improves the overall accuracy of entity classification, segmentation, and annotation, making the system more adaptable to real-world conditions across various industries.

In some implementations, the acquired image data undergoes decoding and reconstruction using a diffusion model selector, an advanced AI-powered module designed to enhance image quality by denoising and reconstructing image features. This module is trained using a noise-based reverse learning process, a technique that systematically removes noise from an image by modeling how visual information deteriorates and reversing this process to restore original details. The application of this method is particularly beneficial in scenarios where image data suffers from motion blur, sensor noise, environmental distortions, or occlusions caused by overlapping objects.

The diffusion model selector recovers occluded or partially visible entities, ensuring that even objects that are partially obstructed, shadowed, or hidden behind other elements are accurately identified and classified. For example, in an industrial setting where machinery components may be stacked or entangled, the system can infer the missing sections of objects based on previously learned patterns. This ability allows for higher classification accuracy in complex or cluttered environments, where conventional image processing methods might struggle to distinguish entities with incomplete visual data.

By leveraging learned patterns from a trained model, the diffusion model selector enhances recognition capabilities by reconstructing missing object parts. This reconstruction process relies on deep-learning-based predictive modeling, where the system identifies likely shapes, textures, and structural properties of obscured entities by referencing a vast dataset of known object features. For instance, if a partially visible industrial tool is obstructed by another object, the model can infer its full shape based on historical training data and contextual cues from the surrounding environment.

Additionally, the denoising process enhances fine-grained details, ensuring that objects with low contrast, poor lighting, or high background noise are still distinguishable. This capability is particularly advantageous for applications in surveillance, autonomous navigation, and defect detection, where precise object recognition is critical for safety and operational efficiency.

Overall, the diffusion model selector ensures that the system maintains high reliability in diverse and challenging conditions, effectively improving object detection, classification accuracy, and contextual understanding of real-world environments.

The method further includes post-processing and segment classification to refine the entity identification process. This step eliminates false positives, merges redundant classifications, and enhances hierarchical structuring of identified entities. The final output is a fully annotated, structured dataset of identified entities, which can be utilized for automated asset tracking, predictive maintenance, digital twin applications, and operational analytics.

The disclosed method presents an AI-driven methodology for real-time, environment-aware entity classification and annotation. By integrating multi-modal imaging, spatial reconstruction, AI-based retrieval, and generative denoising techniques, the system ensures precise, automated entity recognition in dynamic operational environments. The method is particularly beneficial in industrial, healthcare, and infrastructure sectors, where accurate, context-driven classification of assets and entities is critical for decision-making, risk management, and operational efficiency.

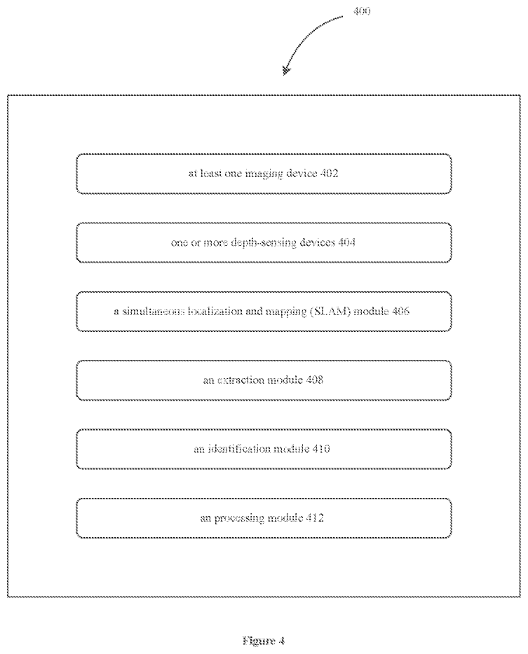

FIG. 4 illustrates a system for classifying and annotating entities detected from image data within an environment according to an embodiment of this disclosure. The system 400 comprises several interconnected components, including imaging devices 402, depth-sensing devices 404, a Simultaneous Localization and Mapping (SLAM) module 406, an extraction module 408, an identification module 410, a processing module 412, and, in some implementations, a decoding module with a diffusion model selector. These components work in unison to acquire, analyze, and categorize detected entities, ensuring high accuracy and structured classification across various operational environments.

The process begins with at least one imaging device 402, which captures image data representing entities in the environment. In some embodiments, this device includes one or more cameras mounted on a user helmet, allowing for real-time and dynamic data acquisition as the user moves through the space. This approach enhances operational flexibility, particularly in industrial settings, infrastructure inspections, and asset management applications, where continuous entity tracking is crucial. Complementing this, depth-sensing devices 404, such as LiDAR sensors, determine the spatial relationships between detected entities, generating depth maps that provide insights into distances, object positions, and environmental structure. These depth measurements are fed into the SLAM module 406, which constructs a 3D representation of the environment by correlating object distances and spatial orientation, ensuring precise localization of all detected entities.

Following the generation of the 3D representation, the extraction module 408 retrieves entity attributes by leveraging a trained AI model embedded with domain-specific templates. These templates consist of structured data models tailored for different industries, ensuring that classification is context-aware and aligns with industry-specific taxonomies. For instance, in a construction setting, entities may be classified as heavy machinery, infrastructure components, or personnel, whereas in a healthcare environment, the classification may include medical devices, patient monitoring systems, or hospital assets. This domain-specific approach enhances classification precision by mapping detected entities to their relevant categories, attributes, and hierarchical structures.

Once entity attributes are extracted, the identification module 410 determines the type and characteristics of each entity using a Retrieval-Augmented Generation (RAG) agentic system. This system enhances classification by retrieving contextual information from pre-existing datasets, enriching entity annotations with historical data, operational guidelines, and usage patterns. The incorporation of external knowledge ensures improved classification accuracy and structured annotations, enabling downstream applications such as automated inventory tracking, operational analytics, and digital record-keeping.

The processing module 412 then refines the acquired data to ensure high-quality classification and annotation. This module performs image quality enhancement, including noise reduction, lighting normalization, and structural feature extraction, to ensure that environmental variations (such as low-light conditions or occlusions) do not hinder classification accuracy. Additionally, the processing module 412 converts 2D images into enhanced 3D structural representations, improving spatial analysis, and classification granularity. Once the entities are classified based on their attributes, structure, and function, the module assigns hierarchical classifications and metadata-rich annotations, making the data interoperable with external systems such as digital twins, industrial automation platforms, and autonomous navigation systems.

In some implementations, the system 400 further includes a decoding module with a diffusion model selector, which denoises, reconstructs, and recovers partially occluded entities. This AI-powered module utilizes a noise-based reverse learning process to infer missing object parts based on learned patterns, ensuring that even partially hidden or obstructed objects are accurately identified and classified. This feature is particularly beneficial in complex, cluttered, or dynamic environments, such as manufacturing plants, warehouses, or disaster response zones, where object visibility may be compromised.

The final stage of the system 400 involves post-processing and segment classification, where identified entities undergo refinement and validation to ensure classification accuracy. The system 400 further segments entities based on their relationships, for example, distinguishing equipment from infrastructure components or differentiating personnel roles based on context. This structured segmentation enables more precise analytics, automated decision-making, and enhanced operational efficiency.

Overall, the system 400 offers a scalable and adaptable solution for real-time entity classification and annotation across diverse industries. By integrating depth sensing, AI-driven classification, retrieval-augmented insights, and advanced image reconstruction techniques, it ensures high precision, adaptability, and interoperability. The system's ability to normalize lighting conditions, reconstruct occluded objects, and enrich classifications with historical data makes it particularly useful in industrial automation, smart infrastructure monitoring, and autonomous asset management applications. Through its multi-layered approach, the system significantly enhances situational awareness, digital record-keeping, and intelligent decision-making, paving the way for more efficient, automated, and data-driven environments.

In yet another embodiment, a non-transitory computer-readable medium is disclosed, having stored thereon computer-executable instructions that, when executed by a processor, cause the processor to execute a method for classifying and annotating entities from images within an environment. The method comprises acquiring image data representing entities within the environment using at least one imaging device and determining spatial relationships between the entities. The method further comprises generating a three-dimensional (3D) representation of the environment using a simultaneous localization and mapping (SLAM) module based on the determined spatial relationships and extracting attributes of the entities from the generated 3D representation based on a trained model. Furthermore, the method comprises identifying types and characteristics of the entities using a retrieval-augmented generation (RAG) agentic system based on the extracted attributes, and classifying and annotating the entities based on the identified types and characteristics of the entities.

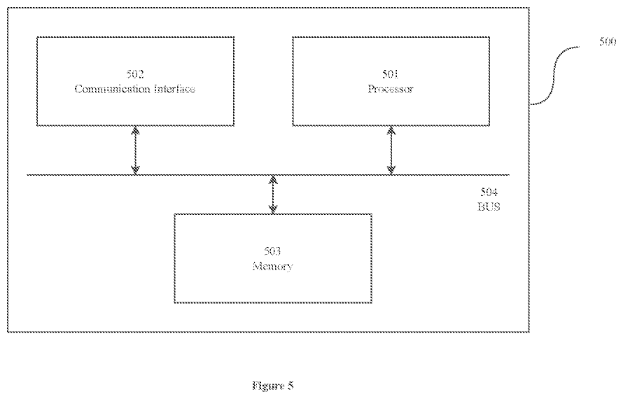

FIG. 5 illustrates a schematic diagram of another communication apparatus 500 according to an embodiment of the disclosure. The communication apparatus 500 includes a processor 501, a communication interface 502, and a memory 503. The processor 501, the communication interface 502, and the memory 503 may be connected to each other via a bus 504. The bus 504 may be a peripheral component interconnect (peripheral component interconnect, PCI) bus, an extended industry standard architecture (extended industry standard architecture, EISA) bus, or the like. The bus 504 may be classified into an address bus, a data bus, a control bus, and the like. For ease of representation, the bus is represented by using only one line in FIG. 5, but it does not indicate that there is only one bus or one type of bus. The processor 501 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 503 may be a volatile memory or a non-volatile memory or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random-access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

Usually, various embodiments of this disclosure may be implemented by hardware or a dedicated circuit, software, logic, or any combination thereof. Some aspects may be implemented by the hardware, and other aspects may be implemented by firmware or software, and may be performed by a controller, a microprocessor, or another computing device. Although aspects of embodiments of this disclosure are shown and described as block diagrams, flowcharts, or some other figures, it should be understood that the blocks, apparatuses, systems, technologies, or methods described in this specification may be implemented as, for example, non-limiting examples, hardware, software, firmware, dedicated circuits or logic, general-purpose hardware or controllers or other computing devices, or a combination thereof.

This disclosure further provides at least one computer program product tangibly stored on a non-transitory computer-readable storage medium. The computer program product includes computer-executable instructions, such as instructions included in a program module, which are executed in a device on a real or virtual processor of a target, to perform the processes/methods described above with reference to the accompanying drawings. Usually, a program module includes a routine, a program, a library, an object, a class, a component, a data structure, or the like that performs a particular task or implements a particular abstract data type. In various embodiments, functions of the program module may be combined, or a function of the program module may be as needed. Machine-executable instructions for the program module may be executed locally or within a distributed device. In the distributed device, the program module may be located in local and remote storage media.

Computer program code for implementing the method disclosed in this disclosure may be written in one or more programming languages. The computer program code may be provided for a processor of a general-purpose computer, a dedicated computer, or another programmable data processing apparatus, so that when the program code is executed by the computer or another programmable data processing apparatus, a function/operation specified in the flowchart and/or the block diagram is implemented. The program code may be completely executed on a computer, partially executed on a computer, independently performed as a software package, partially executed on a computer and partially executed on a remote computer, or completely executed on a remote computer or a server.

In context of this disclosure, the computer program code or related data may be borne in any appropriate carrier, so that the device, the apparatus, or the processor can perform various processing and operations described above. An example of the carrier includes a signal, a computer-readable medium, and the like. An example of the signal may include propagating signals in electrical, optical, radio, sound, or other forms, such as carrier waves and infrared signals.

The computer-readable medium may be any tangible medium that includes or stores a program used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus, or device, or any suitable combination thereof. A more detailed example of the computer-readable storage medium includes an electrical connection with one or more wires, a portable computer disk, a hard disk, a random-access memory (RAM), a read-only memory (ROM), an erasable programmable read-only memory (EPROM or flash memory), an optical storage device, a magnetic storage device, or any suitable combination thereof.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for classifying and annotating entities from images within an environment, the method comprising:
acquiring image data representing entities within the environment using at least one imaging device;
determining spatial relationships between the entities;
generating a three-dimensional (3D) representation of the environment using a simultaneous localization and mapping (SLAM) module based on the determined spatial relationships;
extracting attributes of the entities from the generated 3D representation based on a trained model;
identifying types and characteristics of the entities using a retrieval-augmented generation (RAG) agentic system based on the extracted attributes; and
classifying and annotating the entities based on the identified types and characteristics of the entities.

2. The method of claim 1, further comprises processing the acquired image data for enhancing quality, extracting structural information, and facilitating classification of the entities.

3. The method of claim 2, wherein processing the acquired image data comprises:
enhancing the quality of the acquired image data by reducing noise, normalizing variations, and improving visual clarity of the acquired image data;
generating 3D and structural representations of the entities from the enhanced image data; and
identifying and categorizing the entities based on generated 3D and structural representation.

4. The method of claim 2, wherein processing the acquired image data includes normalizing the image data captured under varying lighting conditions.

5. The method of claim 1, further comprising decoding the acquired image data and processing the decoded image data through a diffusion model selector trained to denoise and reconstruct image features by applying a noise-based reverse learning process.

6. The method of claim 5, wherein the diffusion model selector reconstructs occluded or partially visible entities based on learned patterns from the trained model.

7. The method of claim 1, further comprising performing post-processing and segment classification to refine the identified entities.

8. The method of claim 1, wherein the at least one imaging device comprises one or more cameras mounted on a user helmet.

9. The method of claim 1, wherein the SLAM module correlates distances between the entities within the environment to generate the 3D representation of the environment, measured by one or more depth-sensing devices.

10. The method of claim 1, wherein the trained model comprises domain-specific templates that include structured data models representing different operational environments to facilitate domain-specific entity classification.

11. The method of claim 9, wherein the one or more depth-sensing devices are Light Detection and Ranging (LIDAR) sensors.

12. A system for classifying and annotating entities from images within an environment, the system comprising:
at least one imaging device configured to acquire image data representing entities within the environment;
one or more depth-sensing devices configured to determine spatial relationships between the entities;
a simultaneous localization and mapping (SLAM) module configured to generate a three-dimensional (3D) representation of the environment based on the determined spatial relationships;
an extraction module configured to extract attributes of the entities from the generated 3D representation based on a trained model;
an identification module configured to identify types and characteristics of the entities using a retrieval-augmented generation (RAG) agentic system based on the extracted attributes; and
a processing module configured to classify and annotate the entities based on the identified types and characteristics of the entities.

13. The system of claim 12, wherein the processing module is further configured to process the acquired image data for enhancing quality, extracting structural information, and facilitating classification of the entities.

14. The system of claim 13, wherein the processing module is further configured to:
enhance the quality of the acquired image data by reducing noise, normalizing variations, and improving visual clarity of the acquired image data;
generate 3D and structural representations of the entities from the enhanced image data; and
identify and categorise the entities based on generated 3D and structural representation.

15. The system of claim 13, wherein processing the acquired image data includes normalizing the image data captured under varying lighting conditions.

16. The system of claim 12, further comprising a decoding module configured to decode the acquired image data and process the decoded image data through a diffusion model selector trained to denoise and reconstruct image features by applying a noise-based reverse learning process.

17. The system of claim 12, wherein the diffusion model selector is configured to reconstruct occluded or partially visible entities based on learned patterns from the trained model.

18. The system of claim 12, wherein the processing module is further configured to perform post-processing and segment classification to refine the identified entities.

19. The system of claim 12, wherein the at least one imaging device comprises one or more cameras mounted on a user helmet.

20. A non-transitory computer-readable medium having stored thereon computer-executable instructions that, when executed by a processor, cause the processor to execute a method for classifying and annotating entities from images within an environment, comprising:
acquiring image data representing entities within the environment using at least one imaging device;
determining spatial relationships between the entities;
generating a three-dimensional (3D) representation of the environment using a simultaneous localization and mapping (SLAM) module based on the determined spatial relationships;
extracting attributes of the entities from the generated 3D representation based on a trained model;
identifying types and characteristics of the entities using a retrieval-augmented generation (RAG) agentic system based on the extracted attributes; and
classifying and annotating the entities based on the identified types and characteristics of the entities.
